(19) United States
(12) Patent Application Publication
(10) Pub. No.: US 2013/0167876 A1
(43) Pub. Date: Jul. 4, 2013

(54) SUBSTRATE PROCESSING APPARATUS AND SUBSTRATE PROCESSING METHOD

(71) Applicant: DAINIPPON SCREEN MFG. CO., LTD., Kyoto (JP)

(72) Inventors: Rei TAKEAKI, Kyoto (JP); Toshimitsu NAMBA, Kyoto (JP)

(73) Assignee: DAINIPPON SCREEN MFG. CO., LTD., Kyoto (JP)

(21) Appl. No.: 13/721,285

(22) Filed: Dec. 20, 2012

(30) Foreign Application Priority Data
Dec. 28, 2011 (JP) P2011-287214

(51) Int. Cl. B08B 3/04

(52) U.S. Cl. CPC B08B 3/04
USPC 134/25.1; 134/184

(57) ABSTRACT

A substrate processing apparatus (1) includes a bath body (11), cover members (12), processing liquid nozzles (31) for ejecting an SPM liquid like a shower, and gas nozzles (32) for ejecting nitrogen gas. The processing liquid nozzles eject a processing liquid (91) onto substrates (9) from sidewalls (111) of the bath body (11). By ejecting gas toward lower surfaces of the cover members from the gas nozzles before the substrates are loaded into the bath body, it is possible to remove droplets of the processing liquid deposited on the lower surfaces of the cover members during the previous processing of the substrates or during a temperature control where the processing liquid is ejected from the processing liquid nozzles. It is thereby possible to prevent or reduce deposition of droplets of the processing liquid dropped onto the substrates immediately after being loaded into the bath body.

### TECHNICAL FIELD

The present invention relates to a technique for processing a plurality of substrates in a processing bath.

### BACKGROUND ART

Conventionally, a substrate processing apparatus for performing processings such as cleaning, etching, resist stripping, and the like on a plurality of substrates in a processing bath has been used. As such a substrate processing apparatus, well known is an apparatus in which a sulfuric acid/hydrogen peroxide/water mixture (hereinafter, referred to as an “SPM liquid”) is pooled in the processing bath and a plurality of substrates are immersed therein at the same time (for example, see Japanese Patent Application Laid Open Gazette No. 2007-49022).

Also well known is a substrate washing method in which substrates after being subjected to a liquid treatment are put into a wash bath and washed with the surfaces thereof showered from nozzles which are so arranged as to be opposed to each other in the wash bath while being vertically oscillated in the wash bath (for example, see Japanese Patent Application Laid Open Gazette No. 2000-183011).

In a case where processing is performed by ejecting a processing liquid like a shower in the processing bath, as disclosed in Patent Application Laid Open Gazette No. 2000-183011, the processing liquid is deposited on a cover of the processing bath. When the cover is closed after substrates to be processed next are loaded, there is a possibility that with its oscillation, the droplets of the processing liquid may be dropped onto the substrates from the cover. If the droplets are deposited on the substrates, there is a possibility that particles contained in the droplets may be deposited on the substrates, causing some defects in the substrates.

### SUMMARY OF INVENTION

The present invention is intended for a substrate processing apparatus. The substrate processing apparatus includes a bath body for containing a plurality of substrates which are loaded into the bath body through a carry-in opening provided at an upper portion of the bath body, the plurality of substrates being arranged with respective main surfaces thereof opposed to adjacent ones while standing upright, a cover for opening and closing the carry-in opening of the bath body, a plurality of processing liquid nozzles for ejecting a processing liquid toward the plurality of substrates in the bath body, and at least one gas nozzle for ejecting gas toward a lower surface of the cover.

By the present invention, it is possible to prevent or reduce deposition of droplets of the processing liquid dropped from the cover onto the substrates.

In one preferred embodiment of the present invention, the at least one gas nozzle is provided on at least one sidewall of the bath body, which is opposed to outer peripheral portions of the plurality of substrates.

In another preferred embodiment of the present invention, the plurality of processing liquid nozzles are provided on both sidewalls of the bath body, which are opposed to outer peripheral portions of the plurality of substrates, and the at least one gas nozzle is provided on a sidewall of the bath body, which is opposed to the main surfaces of the plurality of substrates.

Preferably, the lower surface of the cover includes a sloped surface which goes upward as it goes farther from the at least one gas nozzle in the vicinity of the at least one gas nozzle.

Preferably, the substrate processing apparatus further has a control part for controlling ejection of gas from the at least one gas nozzle before the cover opens the carry-in opening in order to load the plurality of substrates into the bath body.

The present invention is also intended for a substrate processing method. The substrate processing method includes the steps of a) ejecting gas from at least one gas nozzle toward a lower surface of a cover, with a carry-in opening provided at an upper portion of a bath body closed by the cover, b) opening the carry-in opening, c) loading a plurality of substrates into the bath body through the carry-in opening, the plurality of substrates being arranged with respective main surfaces thereof opposed to adjacent ones while standing upright, d) closing the carry-in opening by the cover, e) ejecting a processing liquid toward the plurality of substrates from a plurality of processing liquid nozzles, f) opening the carry-in opening, and g) unloading the plurality of substrates through the carry-in opening.

Preferably, the temperature of the processing liquid is regulated by ejecting the processing liquid toward the inside of the bath body from the plurality of processing liquid nozzles before the step a).

In another preferable aspect of the substrate processing method, the method includes the steps of a) opening a carry-in opening provided at an upper portion of a bath body, b) loading a plurality of substrates into the bath body through the carry-in opening, the plurality of substrates being arranged with respective main surfaces thereof opposed to adjacent ones while standing upright, c) closing the carry-in opening by a cover, d) ejecting a processing liquid toward the plurality of substrates from a plurality of processing liquid nozzles, e) starting ejection of gas toward a lower surface of the cover from at least one gas nozzle simultaneously with or immediately before or after the end of the step d) and finishing the ejection, f) opening the carry-in opening, and g) unloading the plurality of substrates through the carry-in opening.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is an elevational view showing a substrate processing apparatus;

FIG. 2 is a side elevation view showing the substrate processing apparatus;

FIG. 3 is a view showing a configuration of a substrate processing apparatus;

FIG. 4 is a flowchart showing an operation flow of the substrate processing apparatus;

FIG. 5 is a flowchart showing an operation flow of the substrate processing apparatus;

FIG. 6 is a view showing the vicinity of a gas nozzle;

FIG. 7 is a flowchart showing part of an operation flow of the substrate processing apparatus;

FIG. 8 is a view simply showing another arrangement of the gas nozzle;

FIG. 9 is a view simply showing still another arrangement of the gas nozzles;

FIG. 10 is a view simply showing yet another arrangement of the gas nozzles;

FIG. 11 is a view simply showing further arrangement of the gas nozzle;

FIG. 12 is a view showing another example of a cover member; and

FIG. 13 is a view showing a collecting part.

### DESCRIPTION OF EMBODIMENTS

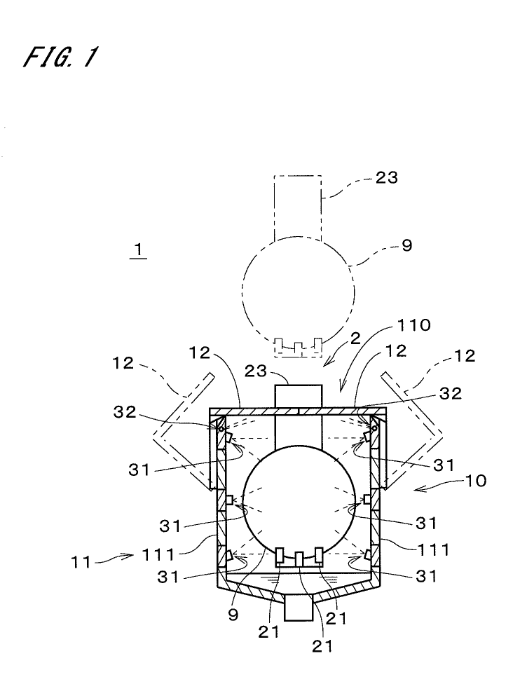

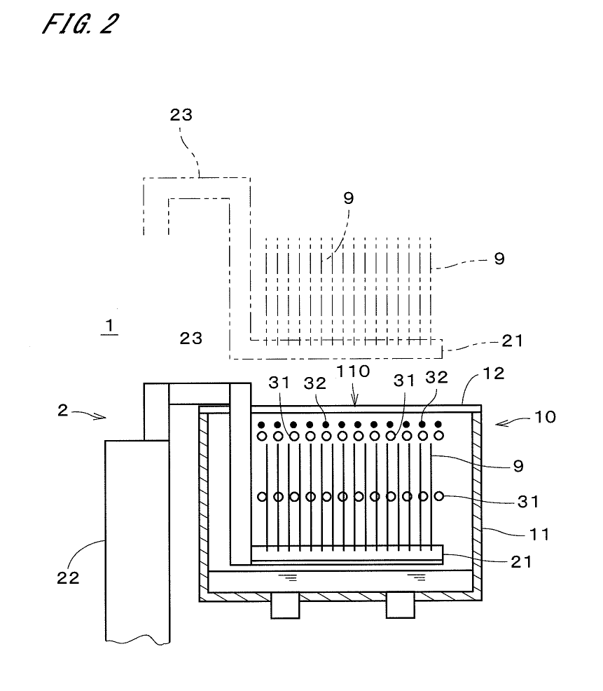

FIG. 1 is an elevational view showing a substrate processing apparatus 1 in accordance with a first preferred embodiment of the present invention, and FIG. 2 is a side elevation view showing the substrate processing apparatus 1. FIG. 1 shows a cross section of a processing bath 10 and FIG. 2 shows another cross section thereof.

The substrate processing apparatus 1 includes the processing bath 10, a lifter 2 for moving substrates 9 up and down, a plurality of processing liquid nozzles 31, and a plurality of gas nozzles 32. The processing bath 10 includes a bath body 11 having a substantially box shape with its upper portion opened and a pair of cover members 12. The pair of cover members serves as a cover. The cover members 12 are arranged left and right in FIG. 1 and rotate around axes perpendicular to paper to open and close the upper opening of the bath body 11. There is almost no clearance nor level difference between lower surfaces of the pair of the cover members 12. Therefore, at least a center area of the lower surfaces of the cover members 12 is flat.

The lifter 2 includes a substrate holding part 21 for holding a plurality of substrates 9 from the lower side, an up-and-down moving mechanism 22 for moving the substrate holding part 21 up and down, and a connecting part 23 for connecting the substrate holding part 21 and the up-and-down moving mechanism 22. The substrate holding part 21 is formed of a plurality of bar-like members extending in a back-and-forth direction which is the left-and-right direction of FIG. 2, and lower portions of the substrates 9 are held in grooves of the bar-like members. The plurality of substrates 9 are arranged with respective main surfaces thereof opposed to adjacent ones while standing upright at regular intervals. The substrates 9 which are arranged in such a manner are contained in the bath body 11.

When the up-and-down moving mechanism 22 moves the substrate holding part 21 up and down, the plurality of substrates 9 are moved between a processing position indicated by solid lines in the processing bath 10 and a transfer position indicated by two-dot chain lines. At the transfer position, the substrates 9 are transferred between a not-shown transfer device and the substrate holding part 21. When the substrate holding part 21 moves up and down, the upper opening of the bath body 11 is opened by the cover members 12. In the following description, the upper opening of the bath body 11 used for loading/unloading of the substrates 9 is referred to as a “carry-in opening 110”.

The cover members 12 are each provided with a notch to get around the connecting part 23 and the carry-in opening 110 can be thereby closed while the substrate holding part 21 is positioned in the bath body 11. When the cover members 12 close the carry-in opening 110 while the substrate holding part 21 holding the plurality of substrates 9 is positioned inside the bath body 11, the substrates 9 are contained in the processing bath 10.

The plurality of processing liquid nozzles 31 are provided on left and right sidewalls 111 of the bath body 11 shown in FIG. 1, which are opposed to outer peripheral portions of the substrates 9. The processing liquid nozzles 31 are arranged in three rows parallel to the arrangement direction of the substrates 9, and the three rows are positioned at an upper portion, a middle portion, and a lower portion of each of the sidewalls 111. The processing liquid nozzles 31 eject a processing liquid toward the plurality of substrates 9 in the bath body 11 like a shower. In the first preferred embodiment, the processing liquid is an SPM liquid (sulfuric acid/hydrogen peroxide/water mixture), and the substrate processing apparatus 1 performs stripping of a resist film and removal of metal on the substrate 9. By adopting a shower method, it is possible to reduce the amount of processing liquid to be used as compared with a case of adopting an immersion method. The processing liquid nozzles 31 in the upper row eject a processing liquid in a direction inclined downward with respect to the horizontal direction and toward the substrates 9. The processing liquid nozzles 31 in the middle row eject a processing liquid in a direction horizontal and toward the substrates 9. The processing liquid nozzles 31 in the lower row eject a processing liquid in a direction inclined upward with respect to the horizontal direction and toward the substrates 9.

The gas nozzles 32 are provided on both the sidewalls 111 of the bath body 11, which are opposed to the outer peripheral portions of the plurality of substrates 9, and above the processing liquid nozzles 31 in the upper row. In other words, the gas nozzles 32 are located between the cover members 12 and the processing liquid nozzles 31 in a height direction. Respective jet ports of the gas nozzles 32 are arranged in parallel to the arrangement direction of the substrates 9, like the processing liquid nozzles 31. From the gas nozzles 32, nitrogen gas is ejected toward lower surfaces of the cover members 12. In other words, the gas nozzles 32 eject gas in a direction inclined upward with respect to the horizontal direction and toward the center from the left and right of FIG. 1. Though the ejections of the gas and the processing liquid are indicated by broken lines in FIG. 1, as a general rule, the gas and the processing liquid are not ejected at the same time.

By providing the gas nozzles 32 on the both sidewalls 111 opposed to the outer peripheral portions of the substrates 9, even when the connecting part 23 exists in the processing bath 10, it is possible to eject the gas toward the cover members 12 without being blocked by the connecting part 23. By providing the gas nozzles 32 between the processing liquid nozzles 31 and the cover members 12, it is possible to suppress deposition of the processing liquid onto the gas nozzles 32 and perform blowing of the gas to the lower surfaces of the cover members 12 from diagonally downward. Further, by providing the gas nozzles 32 on the sidewalls 111, it is possible to easily perform blowing of the gas onto the entire lower surfaces of the cover member 12.

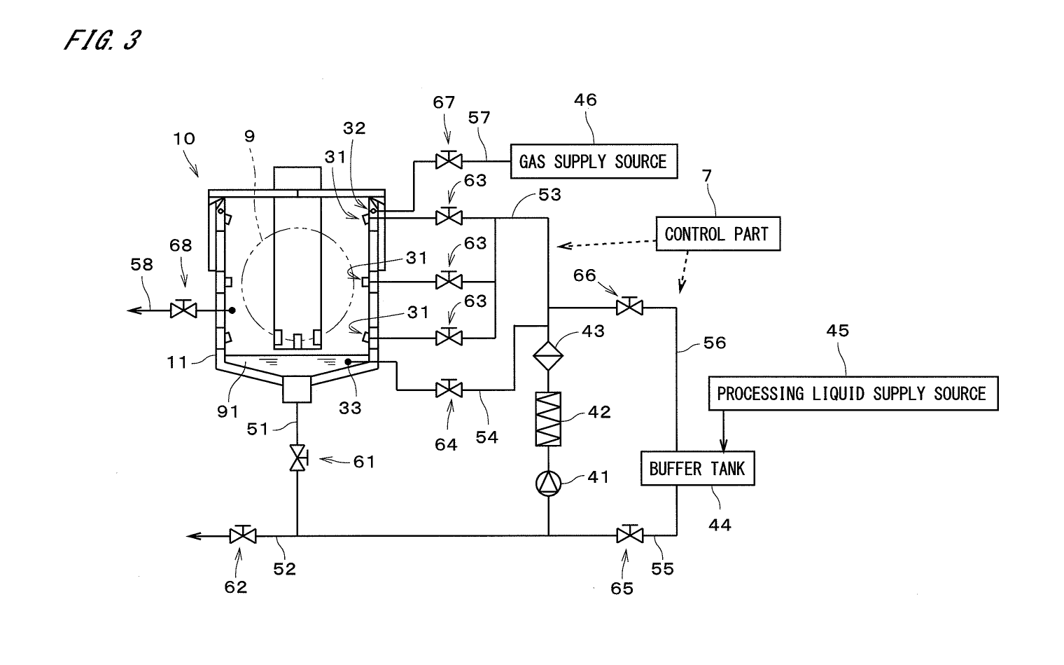

FIG. 3 is a view showing constituent elements connected to the processing bath 10, the processing liquid nozzles 31, and the gas nozzles 32. In FIG. 3, parallel hatch lines in the cross section of the processing bath 10 are omitted. A bottom portion of the bath body 11 is connected to a bath outlet path 51. During the processing, the processing liquid 91 is pooled in the bottom portion of the bath body 11. A valve 61 is provided on the bath outlet path 51, and by opening the valve 61, the processing liquid 91 is discharged from the bath body 11. The bath outlet path 51 branches into one path connected to a pump 41 and another path connected to a liquid discharge path 52. The liquid discharge path 52 is provided with a valve 62. The pump 41 is connected to a heating part 42, and the heating part 42 is connected to a filter 43.

The processing liquid nozzles 31 are connected to the filter 43 through a nozzle supply path 53. The nozzle supply path 53 branches into a plurality of branch paths from the filter 43, going toward the processing liquid nozzles 31. A valve 63 is provided on each of the branch paths. When the pump 41 is driven with the valves 63 opened, the processing liquid 91 is ejected from the processing liquid nozzles 31. The heating part 42 is used for controlling the temperature of the processing liquid 91. The filter 43 removes particles contained in the processing liquid 91. A bypass path 54 branches from the nozzle supply path 53 and is connected to a discharge port 33 at a lower portion of the bath body 11 through a valve 64. FIG. 3 shows only the connection between the processing liquid nozzles 31 on one side and the nozzle supply path 53.

The substrate processing apparatus 1 further includes a buffer tank 44, a processing liquid supply source 45, and a gas supply source 46. The buffer tank 44 is connected to the pump 41 through a tank outlet path 55. A valve 65 is provided on the tank outlet path 55. The buffer tank 44 is connected to the filter 43 through a tank supply path 56. A valve 66 is provided on the tank supply path 56. The buffer tank 44 is connected to the processing liquid supply source 45. In the processing liquid supply source 45, sulfuric acid, hydrogen peroxide water, and deionized water are mixed at a predetermined ratio, to thereby generate an SPM liquid, and the generated SPM liquid is supplied to the buffer tank 44. These liquid solutions may be supplied to the buffer tank 44 without being mixed.

The gas nozzles 32 are connected to the gas supply source 46 through a gas supply path 57. A valve 67 is provided on the gas supply path 57, and by opening the valve 67, nitrogen gas is ejected from the gas nozzles 32. A gas exhaust path 58 is connected to the processing bath 10 and a valve 68 is provided on the gas exhaust path 58.

The substrate processing apparatus 1 includes a control part 7 and the control part 7 controls the respective valves, the pump 41, and the heating part 42. The control part 7 also controls the operation of the lifter 2 and the opening/closing of the cover members 12.

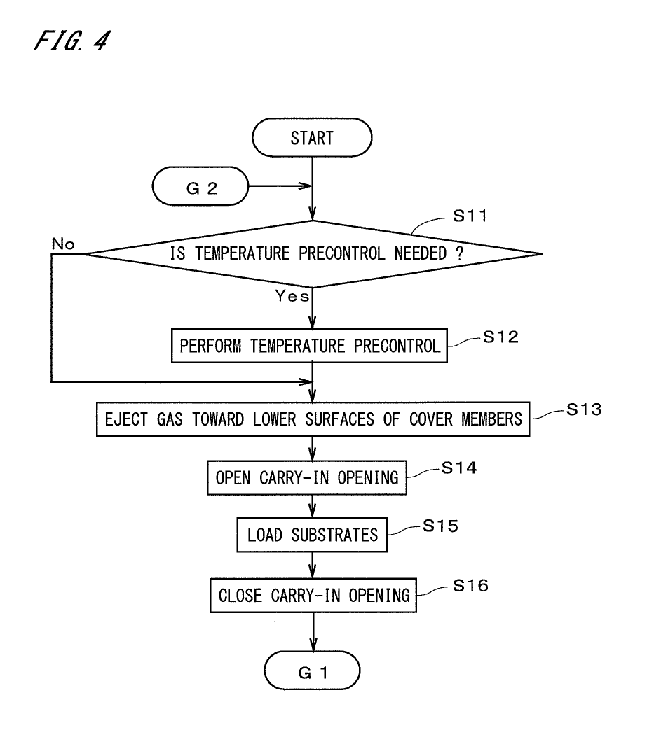

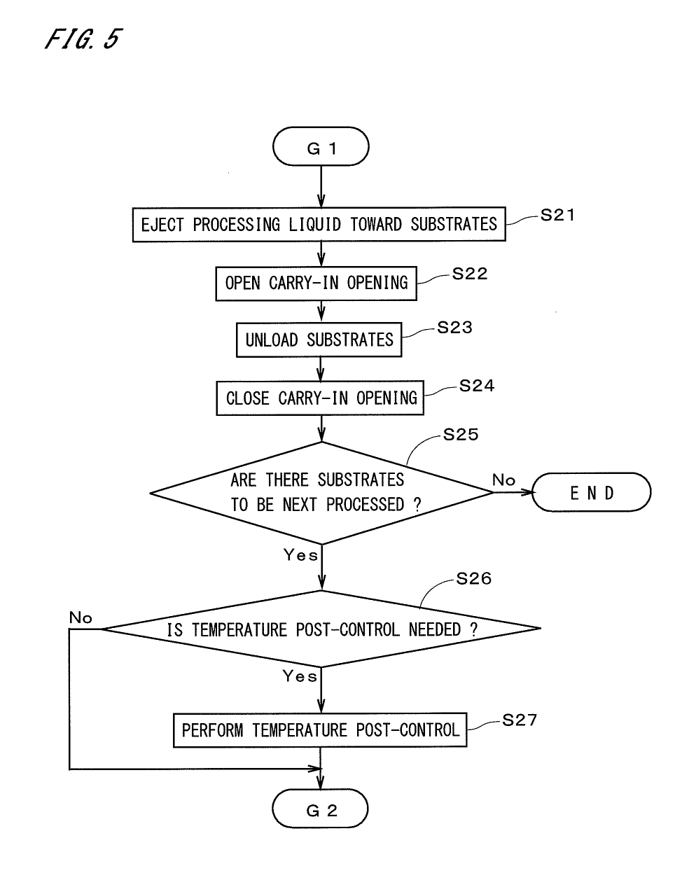

FIGS. 4 and 5 are flowcharts showing an operation flow of the substrate processing apparatus 1. As shown in FIG. 3, when the operation starts, the processing liquid 91 is pooled in the bath body 11 in advance. The amount of processing liquid 91 is the degree that the processing liquid 91 does not come into contact with the substrates 9 disposed at the processing position.

As a specific example, the processing liquid 91 is desirably mixed in the buffer tank 44. The buffer tank 44 is supplied with predetermined kinds of liquids from the processing liquid supply source 45, and the pump 41 is driven with the valves 65 and 66 open and the other valves closed. The processing liquid 91 circulates from the buffer tank 44 to the tank outlet path 55, the pump 41, the heating part 42, the filter 43, and the tank supply path 56. The buffer tank 44 is provided with a thermometer and a concentration meter and controls the heating part 42 and the supply of predetermined kinds of liquids from the processing liquid supply source 45, to thereby give a desired concentration and temperature to the processing liquid 91. By closing the valve 66 and opening the valve 64, the processing liquid 91 is supplied to the processing bath 10 through the tank outlet path 55, the pump 41, the heating part 42, the filter 43, and the bypass path 54. The processing liquid 91 may be pooled in the processing bath 10 by other methods such as direct supply of the liquids from the processing liquid supply source 45 to the processing bath 10, and the like.

In the substrate processing process, first, it is checked if a temperature precontrol is needed (Step S11). In a case, for example, where a long time has elapsed from the previous processing of the substrates 9, the temperature precontrol is performed so as to give desired temperatures to the processing liquid 91, the nozzle supply path 53, the bath body 11, the gas in the processing bath 10, and the like (Step S12). In the temperature precontrol, the valves 61 and 63 are opened and the other valves are closed. The valve 64, however, may be opened. The processing liquid 91 in the processing bath 10 is discharged from the bath outlet path 51, going through the pump 41, the heating part 42, the filter 43, and the nozzle supply path 53, and is ejected from the processing liquid nozzles 31. The bath body 11 is provided with a thermometer and a concentration meter, and the temperature of the processing liquid 91 is regulated to be a desired one and the concentration of the processing liquid 91 is monitored. The ejection of the processing liquid 91 is performed for a predetermined time.

After the temperature precontrol is finished, the control part 7 opens the valve 67 and nitrogen gas is supplied to the gas nozzles 32 from the gas supply source 46 through the gas supply path 57. The gas is thereby ejected from the gas nozzles 32 toward the lower surfaces of the cover members 12 while the carry-in opening 110 is closed by the cover members 12 (Step S13). In actual cases, in order to avoid collision of gas flows from the left and right sides, the gas is ejected alternatively from the gas nozzles 32 on the respective sidewalls 111 on the left and right sides. As a result, most of the processing liquid 91 deposited on the lower surfaces of the cover members 12 in the temperature precontrol or the previous substrate processing flows toward the sidewalls 111.

FIG. 6 is an enlarged cross section showing the vicinity of the gas nozzle 32. The gas nozzles 32 are provided on a nozzle block 311 on which the processing liquid nozzles 31 in the upper row are provided. Specifically, a flow channel 321 extending in a direction perpendicular to the paper (the arrangement direction of the substrates 9) is formed in the nozzle block 311 and a plurality of gas jet ports 322 are formed along the flow channel 321.

An upper end of the nozzle block 311 is sharply pointed at an acute angle and opposed to the lower surface 121 of the cover member 12. There is a small gap 30 between the upper end of the nozzle block 311 and the cover member 12, i.e., the bath body 11 and the cover member 12, and outside the gap 30, provided is a shield part 312 whose cross section is a triangle. The shield part 312 is provided below a portion of the cover member 12, which is positioned outside the bath body 11. The shield part 312 illustratively shown in FIG. 6 has a sloped surface 313 which goes downward as it goes farther from the gap 30. This blocks leakage of droplets or fine particles (mist) of the processing liquid 91 from the gap 30 to the outside of the processing bath 10 in the ejection of the gas. In order to reduce the leakage of the processing liquid 91 from the gap 30, the valve 68 shown in FIG. 3 is opened and the air is thereby exhausted through the gas exhaust path 58 when the gas is ejected. Further, there may be another method of reducing the leakage of the processing liquid 91, for example, where a downflow is formed inside a chamber (not shown) which contains the processing bath 10, to thereby discharge the mist.

When the ejection of the gas is stopped, the cover members 12 open the carry-in opening 110 (Step S14), and the substrate holding part 21 moves up and receives a plurality of substrates 9 from the external transfer device. Then, the substrate holding part 21 moves down and loads the substrates 9 into the bath body 11, and the cover members 12 close the carry-in opening 110 (Steps S15 and S16).

After that, like in the temperature precontrol, the valve 61 and 63 are opened, and the processing liquid 91 in the processing bath 10 is guided through the bath outlet path 51, the pump 41, the heating part 42, the filter 43, and the nozzle supply path 53 to the processing liquid nozzles 31 and ejected from the processing liquid nozzles 31 toward the substrates 9 (Step S21 in FIG. 5). During the substrate processing, the lifter 2 may oscillate the substrate holding part 21 up and down so as to improve the uniformity of the processing.

When the substrate processing is completed, the valve 63 is closed and the cover members 12 open the carry-in opening 110 (Step S22). The substrate holding part 21 moves up and the substrates 9 are thereby unloaded from the bath body 11 and passed to the external transfer device (Step S23). The substrate holding part 21 moves down and the cover members 12 close the carry-in opening 110 (Step S24).

If there are substrates 9 to be next processed (Step S25), it is checked if the temperature post-control is needed (Step S26). The temperature post-control is an operation for maintaining the temperature of the processing liquid 91 to the desired temperature after the processing of the substrates 9 and may be performed in parallel with the unloading of the substrates 9. In the temperature post-control, the valves 61 and 64 are opened and the processing liquid 91 in the processing bath 10 is guided through the bath outlet path 51, the pump 41, the heating part 42, the filter 43, and the bypass path 54 to the discharge port 33. The temperature control of the processing liquid 91 is thereby performed by using the processing bath 10 without ejecting the processing liquid 91. (Step S27).

After that, the process goes back to Step S11, and it is checked if the temperature precontrol is needed before the processing of the next substrates 9. If the temperature precontrol is performed, the temperature precontrol and the gas ejection are performed (Steps S12 and S13), or if the temperature precontrol is not performed, only the gas ejection is performed (Step S13). In any case, the gas is ejected from the gas nozzles 32 by the control of the control part 7 before the cover members 12 open so as to load a plurality of substrates 9 into the bath body 11, and the processing liquid 91 deposited on the lower surfaces of the cover members 12 is thereby removed. Consequently, it is possible to prevent or reduce deposition of the droplets of the processing liquid 91 and the particles on the substrates 9, which are dropped onto the substrates 9 when the cover members 12 are closed after the substrates 9 are loaded.

The above-discussed substrate processing is repeated until the last plurality of substrates 9 are processed, and when all the substrates 9 have been processed, the processing of the substrate processing apparatus 1 is finished (Step S25).

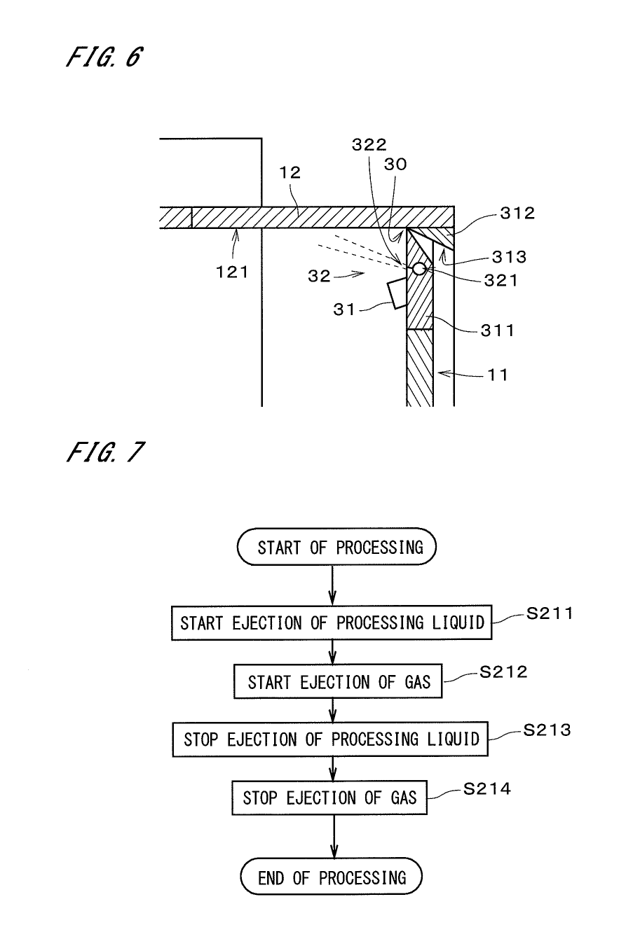

FIG. 7 is a flowchart of another exemplary operation of the substrate processing apparatus 1, showing part of the operation, corresponding to Step S21 of FIG. 5, in detail. In the operation of FIG. 7, after the loading of the substrates 9, first, the ejection of the processing liquid 91 is started (Step S211) and after a predetermined time has elapsed, the ejection of the gas is started (Step S212). Immediately after the gas ejection is started, the ejection of the processing liquid 91 is stopped (Step S213). After that, the gas is ejected alternatively from the gas nozzles 32 on both the sidewalls 111, and then the ejection of the gas is stopped (Step S214).

Since the ejection of the gas is started immediately before the end of the ejection of the processing liquid 91, it is possible to reduce the possibility that the droplets of the processing liquid 91 may drop from the lower surfaces of the cover members 12 onto the substrates 9 after the ejection of the processing liquid 91 is stopped. Further, if it is possible to reduce the possibility that the processing liquid 91 may drop, the ejection of the gas may be started simultaneously with or immediately after the end of the ejection of the processing liquid 91.

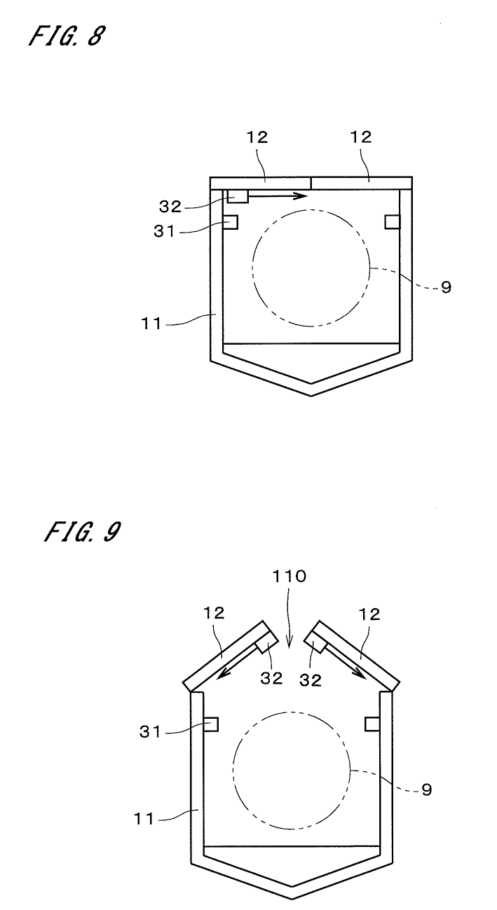

FIGS. 8 to 11 are views each simply showing other arrangements of the gas nozzles 32. Herein, only some of the processing liquid nozzles 31 are shown. In the case of FIG. 8, the gas nozzles 32 are attached to the lower surfaces of the cover members 12. Part of the gas thereby flows toward the lower surfaces of the cover members 12 and the processing liquid deposited on the lower surfaces is washed away. In the case of FIG. 9, the gas nozzles 32 are attached to the lower surfaces of the two cover members 12 on the respective front ends and the gas flows leftward and rightward from the joint side of the cover members 12. In other words, the gas nozzles 32 are provided right above the substrates 9 positioned on the processing position. The processing liquid can be removed from an area right above the substrates 9. In the case of FIG. 9, the ejection of the gas from the gas nozzles 32 may be performed with the carry-in opening 110 closed by the cover members 12 or with the carry-in opening 110 opened by half as shown in FIG. 9.

In the case of FIG. 10, the processing liquid nozzles 31 are provided on an oscillating mechanism 34 and the gas nozzles 32 are also provided on the oscillating mechanism 34. The processing liquid nozzles 31 are oscillated up and down and/or left and right during the ejection of the processing liquid by the oscillating mechanism 34. The processing of the substrates 9 can be thereby performed more uniformly. Also when the gas is ejected from the gas nozzles 32 toward the lower surfaces of the cover members 12, the gas nozzles 32 are oscillated up and down and/or left and right. The oscillating mechanism 34 serves as an orientation changing mechanism for changing the orientation of the gas nozzle 32. It is thereby possible to more appropriately achieve the removal of the processing liquid from the lower surfaces of the cover members 12. Further, instead of oscillating the gas nozzles 32, only the orientation of the gas nozzles 32 may be changed by the orientation changing mechanism to a desired one. The orientation of the gas nozzles 32 may be changed and adjusted by an operator or may be automatically changed by the control part 7.

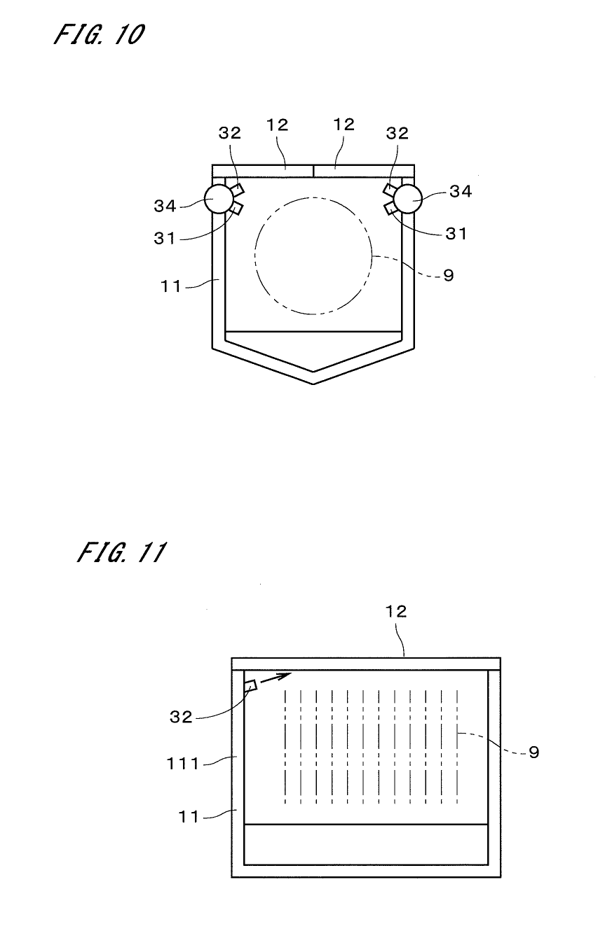

In the case of FIG. 11, the gas nozzles 32 are provided on the sidewall 111 of the bath body 11, which is opposed to the main surfaces of the plurality of substrates 9 and the gas is ejected from the gas nozzles 32 diagonally upward toward the lower surfaces of the cover members 12. In other words, the gas nozzles 32 are provided on the sidewall 111 on the side of the connecting part 23 (see FIG. 2) in the case where the substrate holding part 21 is positioned inside the bath body 11. In actual cases, a plurality of gas nozzles 32 are arranged in a direction perpendicular to the paper in FIG. 11. The processing liquid nozzles 31 are provided on both the sidewalls 111 of the bath body 11, which are opposed to the outer peripheral portions of the plurality of substrates 9, like in the cases of FIGS. 1 and 2. Since the gas nozzles 32 are provided in such a manner, the processing liquid deposited on the lower surfaces of the cover members 12 can be moved to the respective ends of the cover members 12 by the gas without moving across the joint of the cover members 12. Further, it is possible to easily provide the gas nozzles 32 while avoiding interference with a pipe for the processing liquid.

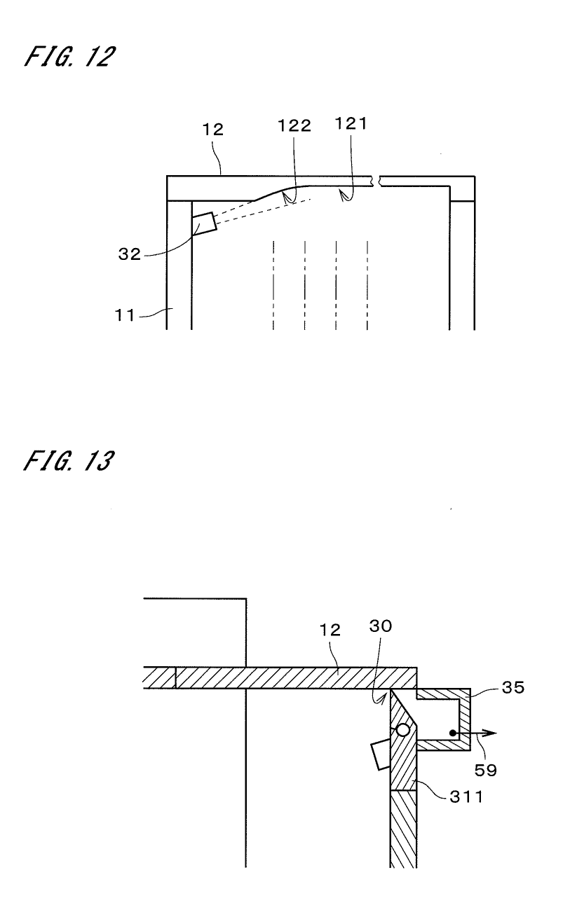

FIG. 12 is a view showing another example of the cover members 12 in the case of FIG. 11. The lower surface 121 of each cover member 12 includes a sloped surface 122 which goes upward as it goes farther from the gas nozzles 32 in the vicinity of the gas nozzles 32. By providing the sloped surface 122 along the gas flow, the processing liquid deposited on the lower surface 121 of the cover member 12 can smoothly move along the gas flow. It is thereby possible to easily remove the processing liquid 91 in a wider range from the lower surface 121 of the cover member 12 as compared with a case where a step is provided in order to make the center area of the cover thinner.

FIG. 13 is a view showing a case where a collecting part 35 is provided instead of the shield part 312 shown in FIG. 6. The collecting part 35 is so provided as to cover the gap 30 between the cover member 12 and the nozzle block 311 and connected to an outlet path 59. The droplets or fine particles of the processing liquid leaked from the gap 30 are received by the collecting part 35 and collected through the outlet path 59. It is thereby possible to prevent the leakage of the processing liquid from the processing bath 10 to the outside through the gap 30.

Though the preferred embodiment of the present invention has been discussed above, the present invention is not limited to the above-discussed preferred embodiment, but allows various variations.

The ejection of the gas may be performed at various timings, and in the case where the temperature precontrol is not performed, for example, the gas ejection may be started immediately after the substrates 9 are unloaded and the cover members 12 close the carry-in opening 110. Conversely, the gas ejection may be performed only immediately before the cover members 12 open the carry-in opening 110. Further, the gas ejection may be performed during the processing of the substrates 9.

The gas may be air or any other kind of gas. The amount of gas to be flowed may be controlled by the control part 7. In the case where the processing liquid nozzles 31 are oscillated up and down, the gas may be ejected from the processing liquid nozzles 31 toward the lower surfaces of the cover members 12.

In the constitution of FIG. 1, the gas nozzles 32 may be provided on only one of the sidewalls 111 of the bath body 11, which are opposed to the outer peripheral portions of the plurality of substrates 9. In this case, the gas flows on the lower surfaces of the cover members 12 only in one direction. By providing the gas nozzles 32 on at least one sidewall 111 opposed to the outer peripheral portions of the substrates 9, it is possible to shorten the travel distance of the droplets of the processing liquid 91 and appropriately remove the droplets in a wider range as compared with the case where the gas nozzles 32 are provided on the sidewall 111 opposed to the main surfaces of the substrates 9.

The number of gas nozzles 32 to be provided may be one. In other words, at least one gas nozzle 32 is provided in the substrate processing apparatus 1. An opening of the gas nozzle 32 may have various shapes, and for example, may have a slit-like shape extending in the horizontal direction.

The technique in which the sloped surface 122 is provide on the lower surface 121 of the cover member 12 as shown in FIG. 12 may be applied to a case where the gas nozzles 32 are provided on the sidewall(s) 111 of the bath body 11, which is (are) opposed to the outer peripheral portions of the substrates 9. The cover members 12 do not have to be provided directly on the bath body 11, and for example, the bath body 11 is contained in a chamber and the cover members may be provided on the chamber. Also in this case, the carry-in opening which is an upper opening of the bath body 11 is substantially opened and closed by the cover members. The cover is not necessarily a pair of cover members. The cover may be one member or more than three members.

The processing liquid nozzles 31 may be provided on the cover members 12. The temperature control operation like the temperature post-control may be performed during the processing of the substrates 9 and may be performed in loading or unloading of the substrates 9.

In the collecting part 35 of FIG. 13, a gas exhaust path for suction of the gas may be provided additionally to the outlet path 59. The gas exhaust path may be provided with a gas-liquid separation function.

The processing to be performed in the substrate processing apparatus 1 is not limited to the processing using the SPM liquid, and any other processing such as a so-called SC-1 (a cleaning process performed at high temperature by using a mixture of aqueous ammonia, hydrogen peroxide water and deionized water), an SC-2 (a cleaning process using a mixture of hydrochloric acid, hydrogen peroxide water and deionized water), or the like may be performed. Further, an object to be processed in the substrate processing apparatus 1 is not limited to a semiconductor substrate but various types of substrates used in a display device, a magneto-optic disk, a photomask, a solar battery, and the like.

The constitutions in the above-discussed preferred embodiments and variations may be combined as appropriate as long as no inconsistency is caused.

While the invention has been shown and described in detail, the foregoing description is in all aspects illustrative and not restrictive. It is therefore understood that numerous modifications and variations can be devised without departing from the scope of the invention. This application claims priority benefit under 35 U.S.C. Section 119 of Japanese Patent Application No. 2011-287214 filed in the Japan Patent Office on Dec. 28, 2011, the entire disclosure of which is incorporated herein by reference.

### REFERENCE SIGNS LIST

1 Substrate processing apparatus
7 Control part
9 Substrate
11 Bath body
12 Cover member
31 Processing liquid nozzle
32 Gas nozzle
34 Oscillating mechanism (Orientation changing mechanism)
35 Collecting part
91 Processing liquid
110 Carry-in opening
111 Sidewall
121 Lower surface
122 Sloped surface
312 Shield part
S11 to S16, S21 to S27, S211 to S214 Step

1. A substrate processing apparatus comprising:
a bath body for containing a plurality of substrates which are loaded into said bath body through a carry-in opening provided at an upper portion of said bath body, said plurality of substrates being arranged with respective main surfaces thereof opposed to adjacent ones while standing upright;
a cover for opening and closing said carry-in opening of said bath body;
a plurality of processing liquid nozzles for ejecting a processing liquid toward said plurality of substrates in said bath body; and
at least one gas nozzle for ejecting gas toward a lower surface of said cover.

2. The substrate processing apparatus according to claim 1, wherein
said at least one gas nozzle is provided on at least one sidewall of said bath body, which is opposed to outer peripheral portions of said plurality of substrates.

3. The substrate processing apparatus according to claim 2, wherein
said at least one gas nozzle is provided on each of both sidewalls of said bath body, which are opposed to said outer peripheral portions of said plurality of substrates.

4. The substrate processing apparatus according to claim 2, wherein
said at least one gas nozzle is located between said cover and said plurality of processing liquid nozzles in a height direction.

5. The substrate processing apparatus according to claim 1, wherein
said plurality of processing liquid nozzles are provided on both sidewalls of said bath body, which are opposed to outer peripheral portions of said plurality of substrates, and
said at least one gas nozzle is provided on a sidewall of said bath body, which is opposed to said main surfaces of said plurality of substrates.

6. The substrate processing apparatus according to claim 1, wherein
said lower surface of said cover includes a sloped surface which goes upward as it goes farther from said at least one gas nozzle in the vicinity of said at least one gas nozzle.

7. The substrate processing apparatus according to claim 1, further comprising:
a shield part for blocking leakage of a processing liquid from a gap between said cover and said bath body or a collecting part for collecting a processing liquid leaked from said gap, which is provided outside said gap.

8. The substrate processing apparatus according to claim 1, further comprising:
an orientation changing mechanism for changing the orientation of said at least one gas nozzle.

9. The substrate processing apparatus according to claim 1, further comprising:
a control part for controlling ejection of gas from said at least one gas nozzle before said cover opens said carry-in opening in order to load a plurality of substrates into said bath body.

10. The substrate processing apparatus according to claim 1, wherein
said processing liquid is a sulfuric acid/hydrogen peroxide/water mixture.

11. A substrate processing method comprising the steps of:
a) ejecting gas from at least one gas nozzle toward a lower surface of a cover, with a carry-in opening provided at an upper portion of a bath body closed by said cover;
b) opening said carry-in opening;
c) loading a plurality of substrates into said bath body through said carry-in opening, said plurality of substrates being arranged with respective main surfaces thereof opposed to adjacent ones while standing upright;
d) closing said carry-in opening by said cover;
e) ejecting a processing liquid toward said plurality of substrates from a plurality of processing liquid nozzles;
f) opening said carry-in opening; and
g) unloading said plurality of substrates through said carry-in opening.

12. The substrate processing method according to claim 11, further comprising the step of:
regulating the temperature of said processing liquid by ejecting said processing liquid toward the inside of said bath body from said plurality of processing liquid nozzles before said step a).

13. The substrate processing method according to claim 11, wherein
said at least one gas nozzle is provided on each of both sidewalls of said bath body, which are opposed to outer peripheral portions of said plurality of substrates, and
gas is ejected from said at least one gas nozzle provided at each of both sidewalls alternatively in said step e).

14. The substrate processing method according to claim 11, wherein
said processing liquid is a sulfuric acid/hydrogen peroxide/water mixture.

15. A substrate processing method comprising the steps of:
a) opening a carry-in opening provided at an upper portion of a bath body;
b) loading a plurality of substrates into said bath body through said carry-in opening, said plurality of substrates being arranged with respective main surfaces thereof opposed to adjacent ones while standing upright;
c) closing said carry-in opening by a cover;
d) ejecting a processing liquid toward said plurality of substrates from a plurality of processing liquid nozzles;
e) starting ejection of gas toward a lower surface of said cover from at least one gas nozzle simultaneously with or immediately before or after the end of said step d) and finishing said ejection;
f) opening said carry-in opening; and
g) unloading said plurality of substrates through said carry-in opening.

16. The substrate processing method according to claim 15, wherein
said processing liquid is a sulfuric acid/hydrogen peroxide/water mixture.
